(19) United States
(12) Patent Application Publication
(10) Pub. No.: US 2023/0082350 A1
(43) Pub. Date: Mar. 16, 2023

(54) TRAVELING LANE RECOGNITION APPARATUS AND TRAVELING LANE RECOGNITION METHOD

(71) Applicant: Mitsubishi Electric Corporation, Tokyo (JP)

(72) Inventors: Masaya ENDO, Tokyo (JP); Yuko OMAGARI, Tokyo (JP)

(73) Assignee: Mitsubishi Electric Corporation, Tokyo (JP)

(21) Appl. No.: 17/800,068

(22) PCT Filed: Apr. 13, 2020
(86) PCT No.: PCT/JP2020/016319

§ 371 Date: Aug. 16, 2022

(51) Int. Cl. B62D 15/02; G06V 20/56

(52) U.S. Cl. CPC B62D 15/025; B62D 15/029; G06V 20/588

(57) ABSTRACT

To provide a traveling lane recognition apparatus-which can suppress deterioration of recognition accuracy of the division line of the own lane, even when the own vehicle crosses the division line by lane change, and the correspondence relation between the own lane and the division line changes. A traveling lane recognition apparatus acquires division line information about division lines of one or a plurality of lanes which are recognizable in front of the own vehicle and include the own lane and the adjacent lane; acquires vehicle movement information; converts the division line information into the division line information of current position basis based on vehicle movement information; determines a correspondence relation between the own lane and each division line; stores the division line information by correlating with the correspondence relation; and estimates estimation division line information based on the division line information of current position.

### TECHNICAL FIELD

The present disclosure is related with a traveling lane recognition apparatus and a traveling lane recognition method.

### BACKGROUND ART

The traveling lane recognition apparatus disclosed in the patent document 1 corrects the plurality of division line information detected in the past on the basis of the vehicle position at the time of information acquisition, to the current position division line information on the basis of the current position of the vehicle; and estimates one current position division line information as the estimation division line information, based on the plurality of current position division line information, and uses the estimation division line information for recognition of the traveling lane.

### CITATION LIST

### Patent Literature

Patent document 1: WO2018/131061

### SUMMARY OF INVENTION

### Technical Problem

However, in the technology of the patent document 1, the case where the own vehicle crosses the division line by lane change, and the division lines on the left side and the right side of the own lane are changed is not considered. If technology of the patent document 1 is executed as it is, since the division line information changes discontinuously before and after crossing the division line by lane change, it is considered that error of the estimation division line information becomes large. In the technology of the patent document 1, even if it is configured that the past current position information is reset after crossing the division line, it is considered that a time lag until the past current position information are accumulated occurs, and the function of calculation processing of the estimation division line information is deteriorated.

Then, the purpose of the present disclosure is to provide a traveling lane recognition apparatus and a traveling lane recognition method which can suppress deterioration of recognition accuracy of the division line of the own lane, even when the own vehicle crosses the division line by lane change, and the correspondence relation between the own lane and the division line changes.

### Solution to Problem

A traveling lane recognition apparatus according to the present disclosure including:

a division line information acquisition unit that acquires division line information regarding position and shape of each division line on a basis of a position of an own vehicle, about division lines of one or a plurality of lanes which are recognizable in front of the own vehicle and include an own lane which is a lane where the own vehicle is traveling, and a lane adjacent to the own lane;

a vehicle movement acquisition unit that acquires vehicle movement information regarding movement of the own vehicle from an acquisition time point of the division line information to a current time point;

a division line information conversion unit that converts the division line information at a plurality of time points of the each division line, into division line information of current position basis on a basis of a current position of the own vehicle at the plurality of time points of the each division line, based on the vehicle movement information;

an own lane determination storage unit that determines a correspondence relation between the own lane and the each division line, based on the division line information of the each division line, and stores one or both of the division line information and the division line information of current position basis, at the plurality of time points of the each division line, by correlating with the correspondence relation;

a division line information estimation unit that estimates estimation division line information which is one division line information, based on the division line information of current position basis at the plurality of time points, about each of a division line on a left side and a division line on a right side of the own lane; and

a traveling lane recognition unit that recognizes a positional relationship of the own lane with respect to the own vehicle, based on the estimation division line information of each of the division line on the left side and the division line on the right side of the own lane.

A traveling lane recognition method according to the present disclosure including:

a division line information acquisition step of acquiring division line information regarding position and shape of each division line on a basis of a position of an own vehicle, about division lines of one or a plurality of lanes which are recognizable in front of the own vehicle and include an own lane which is a lane where the own vehicle is traveling, and a lane adjacent to the own lane;

a vehicle movement acquisition step of acquiring vehicle movement information regarding movement of the own vehicle from an acquisition time point of the division line information to a current time point;

a division line information conversion step of converting the division line information at a plurality of time points of the each division line, into division line information of current position basis on a basis of a current position of the own vehicle at the plurality of time points of the each division line, based on the vehicle movement information;

an own lane determination storage step of determining a correspondence relation between the own lane and the each division line, based on the division line information of the each division line, and storing one or both of the division line information and the division line information of current position basis, at the plurality of time points of the each division line, by correlating with the correspondence relation;

a division line information estimation step of estimating estimation division line information which is one division line information, based on the division line information of current position basis at the plurality of time points, about each of a division line on a left side and a division line on a right side of the own lane; and

a traveling lane recognition step of recognizing a positional relationship of the own lane with respect to the own vehicle, based on the estimation division line information of each of the division line on the left side and the division line on the right side of the own lane.

### Advantage of Invention

According to the traveling lane recognition apparatus and the traveling lane recognition method of the present disclosure, the division line information of one or a plurality of division lines which are recognizable in front of the own vehicle and include the own lane and the adjacent lane are recognized, and the correspondence relation between the own lane and the each division line is determined. Then, one or both of the division line information and the division line information of current position basis, at the plurality of time points of the each division line which were acquired at the plurality of time points of this time and past are stored by correlating with the correspondence relation. Accordingly, not only the division line information of the own lane but also the division line information of the adjacent lane are stored and accumulated.

Then, also in the case where the division line of the own lane is changed by crossing the division line with the lane change, since the correspondence relation between the own lane and the each division line is determined, and one or both of the division line information and the division line information of current position basis of the each division line are stored by correlating with the correspondence relation, the division line information and the division line information of current position basis of the adjacent lane which were detected at the plurality of past time points can be used as information of the own lane, and the estimation division line information of the own lane can be estimated. Accordingly, even when the division line of the own lane is changed by the lane change, the estimation division line information of the own lane can be calculated continuously without interruption, and the positional relationship of the own lane with respect to the own vehicle can be recognized. Since, at the time of changing the division line, the division line information and the division line information of current position basis at the plurality of past time points which are stored about the division line of the adjacent lane are used, the estimation accuracy of the estimation division line information can be improved more than when only the division line information of the own lane acquired this time is used.

The division line information of current position basis used for estimation of the estimation division line information are the division line information on the basis of the current position of the own vehicle obtained by converting the division line information acquired in the past based on the vehicle movement information from the acquisition time point to the current time point. Accordingly, the division line information of current position basis at the plurality of time points in the each division line become equivalent information with each other, if the each division line information can be detected with good accuracy. However, actually, there is variation due to detection error. By estimating the one estimation division line information based on the division line information of current position basis at the plurality of time points, the influence of detection error can be reduced more than when only the division line information acquired this time is used, and accuracy can be improved.

Also in the case where the shape of the division line of the adjacent lane is different from the shape of the division line of the own lane at the junction point and the branch point of road, and the like, the division line information of the adjacent lane at the plurality of past time points are used after changing the division line. Accordingly, the estimation division line information of the adjacent lane whose shape is different from the own lane can be estimated with good accuracy. Or, although the recognizability of the division line of the own lane is not good due to existence of the preceding vehicle, visibility of the division line, and the like, there is the case where the recognizability of the division line of the adjacent lane is good. In this case, after changing the division line, the estimation division line information of the own lane can be estimated with good accuracy using the past division line information of the adjacent lane with good recognizability.

Therefore, regardless of the presence or absence of change of the division line of the own lane by the lane change, the estimation division line information of the own lane can be continuously estimated with good accuracy, and the positional relationship of the own lane with respect to the own vehicle can be recognized with good accuracy.

### BRIEF DESCRIPTION OF THE DRAWINGS

FIG. 1 is a schematic block diagram of the traveling lane recognition apparatus according to Embodiment 1;

FIG. 2 is a hardware configuration figure of the traveling lane recognition apparatus according to Embodiment 1;

FIG. 3 is a hardware configuration figure of the traveling lane recognition apparatus according to Embodiment 1;

FIG. 4 is a flowchart for explaining schematic processing of the traveling lane recognition apparatus according to Embodiment 1;

FIG. 5 is a figure for explaining the own vehicle coordinate system according to Embodiment 1;

FIG. 6 is a figure explaining the movement information of the own vehicle according to Embodiment 1;

FIG. 7 is a figure explaining the stored data of the movement information of the own vehicle correlated with the history number according to Embodiment 1;

FIG. 8 is a figure explaining the stored data of the division line information correlated with the identification information of division line and the history number according to Embodiment 1;

FIG. 9 is a figure explaining the stored data of the division line information of current position basis correlated with the identification information of division line and the history number according to Embodiment 1;

FIG. 10 is a figure for explaining the behavior at the time of lane change according to Embodiment 1;

FIG. 11 is a time chart explaining the processing at the time of lane change according to Embodiment 1;

FIG. 12 is a figure explaining the change of the division line information among the identification information of division line at the time of the crossing determination of division line according to Embodiment 1;

FIG. 13 is a figure explaining the change of the division line information of current position basis among the identification information of division line at the time of the crossing determination of division line according to Embodiment 1;

FIG. 14 is a flowchart explaining the lane determination storage processing according to Embodiment 1;

FIG. 15 is a flowchart explaining the division line information estimation processing according to Embodiment 1;

FIG. 16 is a figure explaining the recognition of the own lane based on the estimation division line information according to Embodiment 1; and

FIG. 17 is a flowchart explaining the division line information estimation processing according to Embodiment 2.

### DETAILED DESCRIPTION OF THE EMBODIMENTS

### 1. Embodiment 1

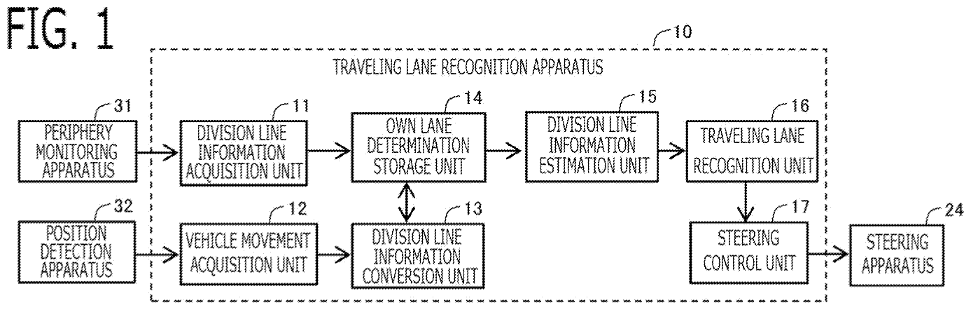

A traveling lane recognition apparatus 10 and a traveling lane recognition method according to Embodiment 1 will be explained with reference to drawings. FIG. 1 is a schematic block diagram of the traveling lane recognition apparatus 10.

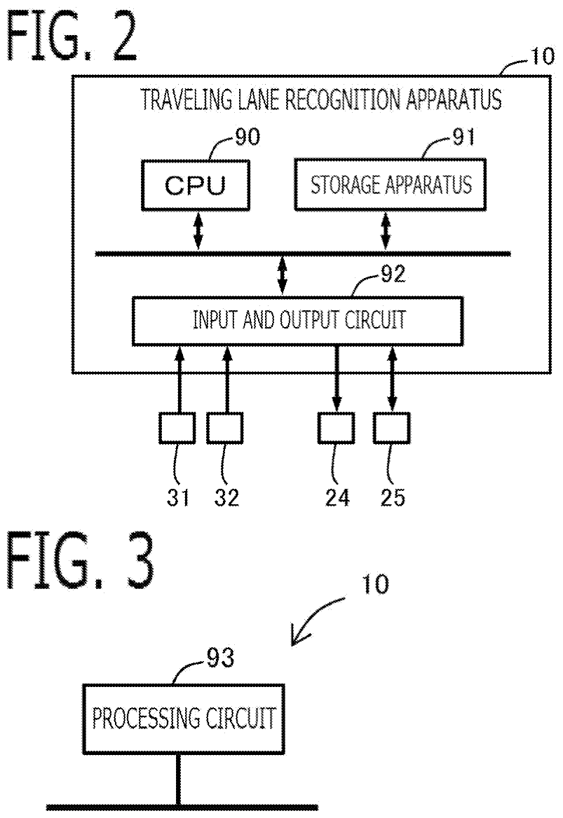

The traveling lane recognition apparatus 10 is provided with processing units such as a division line information acquisition unit 11, a vehicle movement acquisition unit 12, a division line information conversion unit 13, an own lane determination storage unit 14, a division line information estimation unit 15, a traveling lane recognition unit 16, and a steering control unit 17. Each processing of the traveling lane recognition apparatus 10 is realized by processing circuits provided in the traveling lane recognition apparatus 10. As shown in FIG. 2, specifically, the traveling lane recognition apparatus 10 is provided with an arithmetic processor 90 such as CPU (Central Processing Unit), storage apparatuses 91, an input and output circuit 92 which outputs and inputs external signals to the arithmetic processor 90, and the like.

As the arithmetic processor 90, ASIC (Application Specific Integrated Circuit), IC (Integrated Circuit), DSP (Digital Signal Processor), FPGA (Field Programmable Gate Array), GPU (Graphics Processing Unit), AI (Artificial Intelligence) chip, various kinds of logical circuits, various kinds of signal processing circuits, and the like may be provided. As the arithmetic processor 90, a plurality of the same type ones or the different type ones may be provided, and each processing may be shared and executed. As the storage apparatuses 91, a RAM (Random Access Memory) which can read data and write data from the arithmetic processor 90, a ROM (Read Only Memory) which can read data from the arithmetic processor 90, and the like are provided. As the storage apparatuses 91, various kinds of storage apparatus, such as a flash memory, EEPROM (Electrically Erasable Programmable Read Only Memory), a hard disk, and a DVD apparatus may be used.

The input and output circuit 92 is provided with a communication device, an A/D converter, an input/output port, a driving circuit, and the like. The input and output circuit 92 is connected to a periphery monitoring apparatus 31, a position detection apparatus 32, a steering apparatus 24, a driving support system 25, and the like, and communicates with these apparatuses.

Then, the arithmetic processor 90 runs software items (programs) stored in the storage apparatus 91 such as a ROM and collaborates with other hardware devices in the traveling lane recognition apparatus 10, such as the storage apparatus 91, and the input and output circuit 92, so that the respective functions of the processing units 11 to 17 included in the traveling lane recognition apparatus 10 are realized. Setting data items such as a threshold value to be utilized in the processing units 11 to 17 are stored, as part of software items (programs), in the storage apparatus 91 such as a ROM. Each function of the traveling lane recognition apparatus 10 will be explained in detail below.

Alternatively, as shown in FIG. 3, the traveling lane recognition apparatus 10 may be provided with a dedicated hardware 93 as the processing circuit, for example, a single circuit, a combined circuit, a programmed processor, a parallel programmed processor, ASIC, FPGA, GPU, AI chip, or a circuit which combined these.

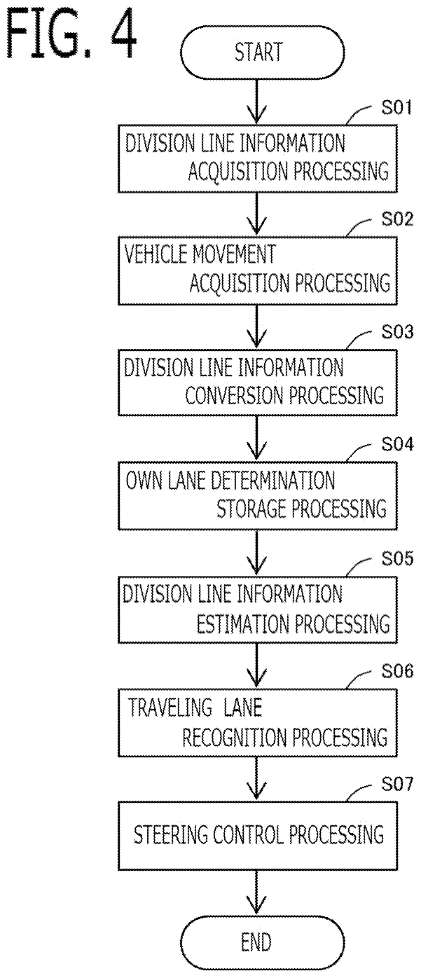

FIG. 4 is a schematic flowchart for explaining the procedure (the traveling lane recognition method) of processing of the traveling lane recognition apparatus 10 according to the present embodiment. The processing of the flowchart in FIG. 4 is recurrently executed every predetermined operation period by the arithmetic processor 90 executing software (a program) stored in the storage apparatus 91. The calculation period is set to 0.01 seconds, for example.

### 1-1. Division Line Information Acquisition Unit 11

In the step S01 of FIG. 4, the division line information acquisition unit 11 executes a division line information acquisition processing (a division line information acquisition step) that acquires division line information regarding position and shape of each division line on a basis of a position of an own vehicle, about division lines of one or a plurality of lanes which are recognizable in front of the own vehicle and include an own lane which is a lane where the own vehicle is traveling, and a lane adjacent to the own lane.

The division line information acquisition unit 11 detects the division line which can be recognized, and acquires division line information, based on detection information of the periphery monitoring apparatus 31. The periphery monitoring apparatus 31 includes a camera which monitors the front of the vehicle. Various kinds of well-known image processing is performed to picture imaged by the camera, and the division line of lane is recognized. Although the division line is mainly a white line, it is not limited to the white line, and a roadside object, such as a guardrail, a pole, a road shoulder, and a wall, may be recognized as the division line. As the periphery monitoring apparatus 31, a laser radar may be used, and the white line may be recognized from the points that the reflection luminance of the laser radar is high.

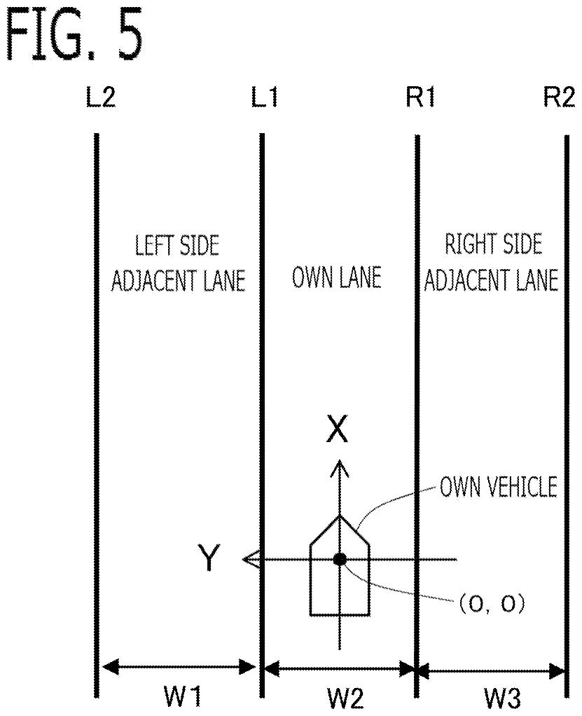

The division line information acquisition unit 11 acquires the division line information regarding position and shape of each recognized division line in the own vehicle coordinate system. As shown in FIG. 5, the own vehicle coordinate system is a coordinate system which sets the front direction and the lateral direction of the own vehicle as two coordinate axes X and Y. The origin of the own vehicle coordinate system is set at a vicinity of a center of the own vehicle, such as a neutral steer point.

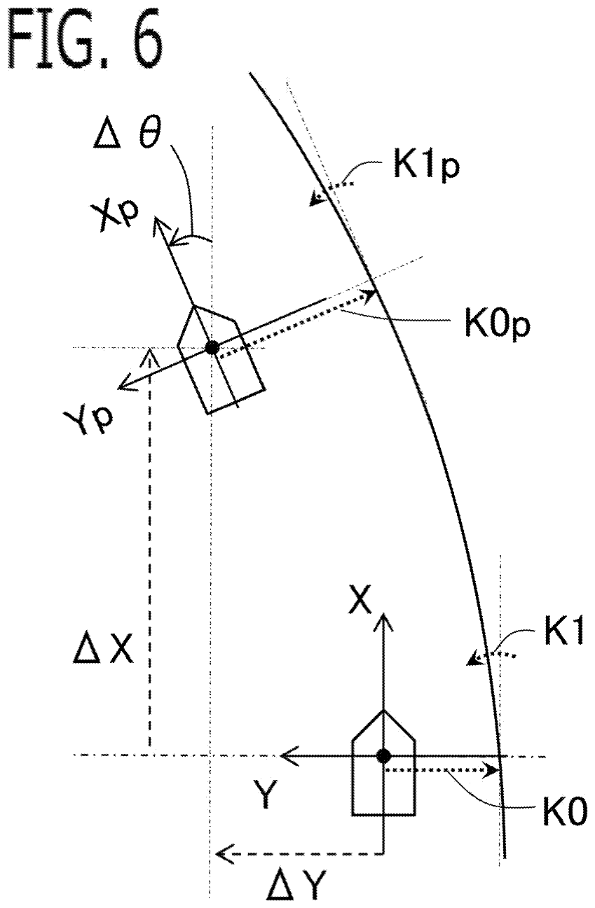

In the present embodiment, as shown in FIG. 6, the division line information acquisition unit 11 acquires, as the division line information of the each division line, information including a division line distance K0 which is a distance between the own vehicle and a part of the division line located in a lateral direction of the own vehicle, a division line angle K1 which is an inclination of the part of the division line located in the lateral direction of the own vehicle with respect to a front direction of the own vehicle, and a curvature K2 of the division line. In the present embodiment, a curvature change rate K3 of division line is further included in the division line information. Using these parameters K0 to K3 of the division line information, the position of each division line in the own vehicle coordinate system can be calculated by the next equation. That is to say, each division line is approximated by an approximation equation expressed by a third-order polynomial which sets the position Y in the lateral direction and the position X in the front direction of the division line in the own vehicle coordinate system as variables. Each order coefficient is acquired as the parameters K0 to K3 indicating the division line information. It may be approximated by a second-order polynomial which does not have the third-order term of the curvature change rate K3.

$$Y = K 0 + K 1 \times X + \frac{1}{2} \times K 2 \times {X}^{2} + \frac{1}{6} \times K 3 \times {X}^{3} \qquad ( 1 )$$

As shown in FIG. 5, the division line information acquisition unit 11 acquires the division line information of not only right and left division lines of the own lane but also a division line of a lane adjacent to the own lane.

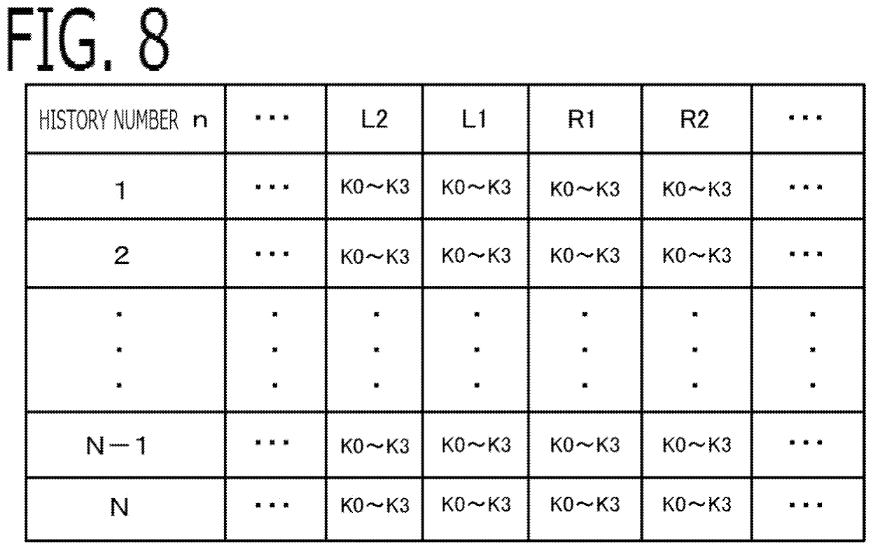

As described in detail later, for example, as shown in FIG. 8, the own lane determination storage unit 14 stores the division line information (K0 to K3) of each division line acquired at each time point, to the rewritable storage apparatus 91 such as RAM, by correlating with identification information L1, R1, L2, R2 of each division line and a history number n indicating acquisition time point (n=1, 2, . . . , N-1, N). The history number n of the division line information acquired this time is set to 1, and the history number n is increased one by one, as the division line information becomes old.

### 1-2. Vehicle Movement Acquisition Unit 12

In the step S02 of FIG. 4, the vehicle movement acquisition unit 12 executes a vehicle movement acquisition processing (a vehicle movement acquisition step) that acquires vehicle movement information regarding movement of the own vehicle from the acquisition time point of the division line information to the current time point. In the present embodiment, the vehicle movement acquisition unit 12 acquires a moving distances ΔX and ΔY in the front direction X and the lateral direction Y of the own vehicle on the basis of the own vehicle (the own vehicle coordinate system) at the acquisition time point of the division line information, and a change amount of yaw angle Δθ, as the vehicle movement information.

The vehicle movement acquisition unit 12 acquires the vehicle movement information, based on the detection information of the position detection apparatus 32. As the position detecting apparatus 32, a speed sensor, a yaw rate sensor, and the like are provided. The speed sensor is a sensor which detects a travelling speed (vehicle speed) of the own vehicle, and detects a rotational speed of the wheels, and the like. An acceleration sensor may be provided, and the travelling speed of vehicle may be calculated based on acceleration. The yaw rate sensor is a sensor which detects yaw rate information relevant to a yaw rate of the own vehicle. As the yaw rate information, a yaw rate, a yaw angle, a yaw moment, or the like is detected. If the yaw angle is time-differentiated, the yaw rate can be calculated. If prescribed calculation is performed using the yaw moment, the yaw rate can be calculated.

As shown in FIG. 6, the vehicle movement acquisition unit 12 calculates the moving distances ΔX and Δ Y of the own vehicle in the own vehicle coordinate system at the acquisition time point of the division line information, and the change amount of yaw angle Δθ of the own vehicle, from the acquisition time point of division line information to the current time point, based on detection values of the vehicle speed and the yaw rate of the own vehicle.

In the present embodiment, the vehicle movement acquisition unit 12 calculates the moving distances ΔX and ΔY of the own vehicle in the own vehicle coordinate system at the acquisition time point of the division line information, and the change amount of yaw angle Δθ of the own vehicle, from the plurality of past time points when the division line information were acquired to the current time point. The moving distances ΔX and ΔY and the change amount of yaw angle Δθ are calculated by integrating the detection values of the vehicle speed and the yaw rate of the own vehicle which were detected at the plurality of past time points.

For example, the vehicle movement acquisition unit 12 calculates the change amount of yaw angle Δθ by integrating the yaw rate from the past time point to the current time point, and calculates the moving distance ΔL by integrating the vehicle speed from the past time point to the current time point. Then, as shown in the next equation, the vehicle movement acquisition unit 12 divides the moving distance ΔL into a component ΔX in the front direction X and a component ΔY in the lateral direction Y of moving distance in the own vehicle coordinate system at the acquisition time point of the division line information, using the change amount of yaw angle Δθ. If Δθ is small, approximate operation can be performed.

$$Δ X = Δ L \times cos Δθ ≅ Δ L \times ( 1 - \frac{1}{2} Δ {θ}^{2} ) \qquad ( 2 )$$

$$Δ Y = Δ L \times sin Δθ ≅ Δ L \times Δθ$$

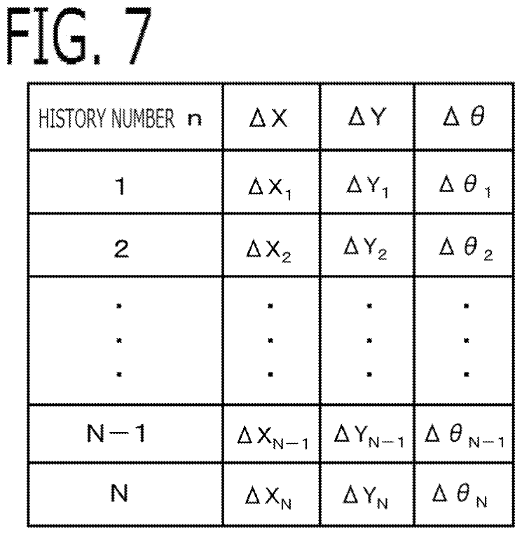

Then, as shown in FIG. 7, the vehicle movement acquisition unit 12 stores the moving distances ΔX and ΔY and the change amount of yaw angle Δθ of the own vehicle from each acquisition time point to the current time point, to the rewritable storage apparatus 91 such as RAM, by correlating with the history number n (n=1, 2, . . . , N-1, N).

### <Influence of Processing Delay>

There is a case where processing delay from the time point when the periphery monitoring apparatus 31 detected the division line, to the time point of processing the division line information cannot be ignored. As the cause of this processing delay, there are a processing time until the imaged picture of the camera and the like is processed and the division line information is calculated, a communication time necessary for communication, and the like. If the processing delay is an ignorable level (for example, about 0.01 sec), a time lag from the acquisition time point of this time division line information to the current time point can be ignored. On the other hand, if the processing delay is an unignorable level (for example, about 0.1 sec), since the vehicle moves several meters during its processing delay, the moving distances ΔX and ΔY of the own vehicle and the change amount of yaw angle Δθ are further integrated during its processing delay.

### 1-3. Division Line Information Conversion Unit 13

In the step S03 of FIG. 4, the division line information conversion unit 13 executes a division line information conversion process (a division line information conversion step) that converts a plurality of past division line information of the each division line acquired at a plurality of past time points, into a plurality of division line information of current position basis of the each division line on a basis of a current position of the own vehicle, based on the vehicle movement information.

In the present embodiment, the division line information conversion unit 13 converts the division line information of each division line acquired at each time point, into the division line information of current position basis of the each division line on the basis of the current position of the own vehicle, based on the vehicle movement information from the acquisition time point to the current time point.

As mentioned above, if the time lag from this time point when detecting the division line to the current time point when processing the division line information cannot be ignored, the division line information conversion unit 13 also converts the division line information of the each division line acquired this time, into the division line information of current position basis of the each division line on the basis of the current position of the own vehicle, based on the vehicle movement information from this time acquisition time point to the current time point.

The division line information of current position basis of the each division line at the plurality of time points become equivalent information with each other, if each division line information can be detected with good accuracy.

### <Details of Conversion Process>

The division line information conversion unit 13 converts the division line distance K0, the division line angle K1, the curvature of division line K2, and the curvature change rate of division line K3 as the division line information acquired at each time point, into a division line distance K0p, a division line angle K1p, a curvature of division line K2p, and a curvature change rate of division line K3p of current position basis on the basis of the current position of the own vehicle, based on the moving distances ΔX and ΔY, and the change amount of yaw angle Δθ of the own vehicle from the acquisition time point of the division line information to the current time point.

In the following, the detail of conversion process will be explained. The division line information conversion unit 13 executes a conversion process which converts the division line information K0 to K3 of the each division line of each history number n stored in the storage apparatus 91, into the division line information of current position basis K0p to K3p, using the vehicle movement information ΔX, Δ Y, Δθ of corresponding each history number n.

### <In the Case of High Speed Traveling>

When traveling at high speed, the moving distance ΔY in the lateral direction and the change amount of yaw angle Δθ become small, and can be ignored. Accordingly, as shown in the next equation, the division line information conversion unit 13 calculates the division line information K0p, K1p, K2p, K3p of current position basis on the basis of the current own vehicle coordinate system where the own vehicle moved by the distance ΔX in the front direction X. This equation is obtained by substituting X=Xp+ΔX and Y=Yp for the equation (1).

$$Y p = K 0 p + K 1 p \times X p + \frac{1}{2} \times K 2 p \times {Xp}^{2} + \frac{1}{6} \times K 3 p \times {Xp}^{3} \qquad ( 3 )$$

$$K 0 p = K 0 + K 1 \times Δ X + \frac{1}{2} \times K 2 \times Δ {X}^{2} + \frac{1}{6} \times K 3 \times Δ {X}^{3}$$

$$K 1 p = K 1 + K 2 \times Δ X + \frac{1}{2} \times K 3 \times Δ {X}^{2}$$

$$K 2 p = K 2 + K 3 \times Δ X$$

$$K 3 p = K 3$$

### <In the Case of Low Speed Traveling>

On the other hand, when traveling at comparatively low speed, such as the traffic congestion, the moving distance ΔY in the lateral direction and the change amount of yaw angle Δθ becomes so large that it cannot be ignored. Accordingly, as shown in the next equation, the division line information conversion unit 13 calculates the division line information K0p, K1p, K2p, K3p of current position basis on the basis of the current own vehicle coordinate system where the own vehicle moved by the moving distances ΔX and ΔY in the front direction X and the lateral direction Y, and rotated by the change amount of yaw angle Δθ. This equation is obtained by substituting X=Xp+Δx and Y=Yp+Δy for the equation (1) and performing rotating coordinate conversion by the change amount of yaw angle Δθ. At the time of high speed traveling, the equation (4) may be used and the calculation result similar to the equation (3) is obtained.

$$Yp = K 0 p + K 1 p \times Xp + \frac{1}{2} \times K 2 p \times {Xp}^{2} + \frac{1}{6} \times K 3 p \times {Xp}^{3} \qquad ( 4 )$$

$$K 0 p = ( K 0 + K 1 \times Δ X + \frac{1}{2} \times K 2 \times Δ {X}^{2} + \frac{1}{6} \times K 3 \times Δ {X}^{3} - Δ Y ) \times cos Δθ$$

$$K 1 p = K 1 + K 2 \times Δ X + \frac{1}{2} \times K 3 \times Δ {X}^{2} - Δθ$$

$$K 2 p = K 2 + K 3 \times Δ X$$

$$K 3 p = K 3$$

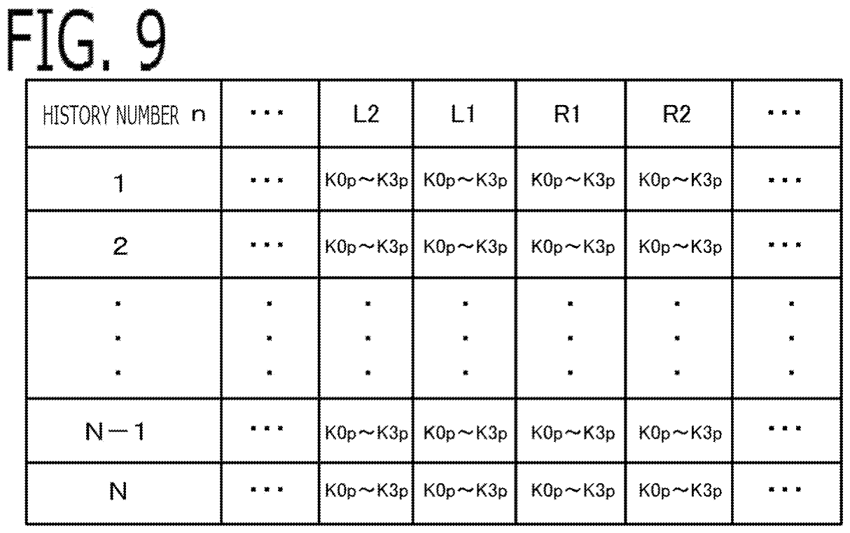

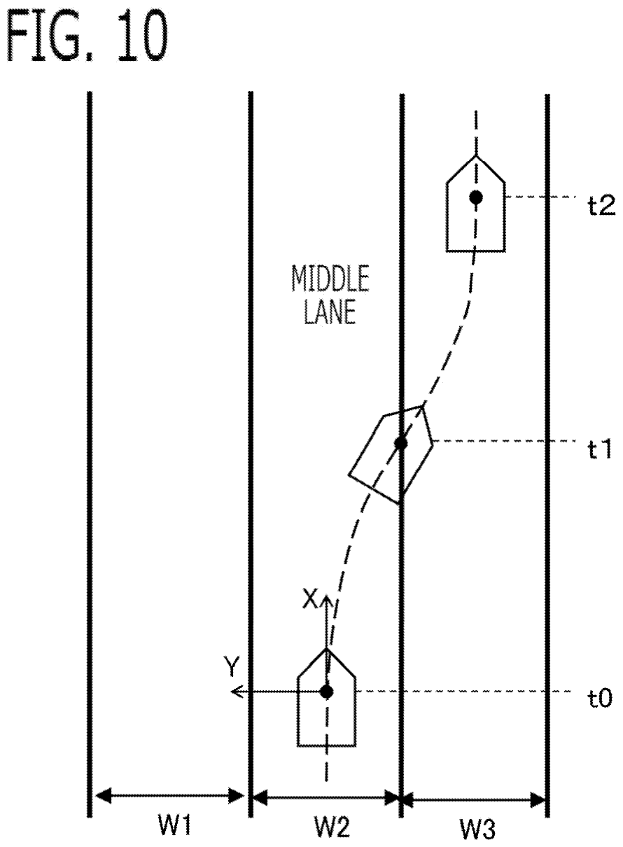

Then, as shown in FIG. 9, the own lane determination storage unit 14 described below stores the division line information K0p to K3p of current position basis after conversion of the each division line of each history number n, to the rewritable storage apparatus 91 such as RAM, by correlating with the identification information L1, R1, L2, R2, . . . of the each division line, and the history number n.

### 1-4. Own Lane Determination Storage Unit 14

In the step S04 of FIG. 4, the own lane determination storage unit 14 executes an own lane determination storage processing (an own lane determination storage step) that determines a correspondence relation between the own lane and the each division line, based on the division line information of the each division line acquired this time; and stores one or both (in this example, both) of the division line information and the division line information of current position basis at the plurality of time points of the each division line, by correlating with the correspondence relation between the own lane and the each division line. As shown in FIG. 5, for example, as the correspondence relation, the division line on the left side of the own lane is determined as the left first division line L1; the division lines on the further left side are determined as the left second division line L2, the left third division line L3, and . . . , in order; the division line on the right side of the own lane is determined as the right first division line R1; and the division lines on the further right side are determined as the right second division line R2, the right third division line R3, and . . . , in order. When there is no corresponding division line, it is determined that its division line does not exist.

### <Recognition of Each Division Line of Right Side and Left Side Based on Division Line Distance K0>

The own lane determination storage unit 14 recognizes the correspondence relation between the own lane and the each division line, based on the division line distance K0 of the each division line acquired this time.

The own lane determination storage unit 14 recognizes the division line which is closest to the own vehicle on the right side of the own vehicle among the division line distances K0 of the respective division lines, as the division line on the right side of the own lane (the right first division line R1); and recognizes the division line which is closest to the own vehicle on the left side of the own vehicle among the division line distances K0 of the respective division lines, as the division line on the left side of the own lane (the left first division line L1).

In the present embodiment, the own lane determination storage unit 14 recognizes the division line whose division line distance K0 is smallest among the division lines whose division line distances K0 are positive values, as the left first division line L1 corresponding to the left side division line of the own lane; recognizes the division line whose division line distance K0 is the second smallest, as the left second division line L2; and recognizes the division line whose division line distance K0 is the third smallest, as the left third division line L3. The own lane determination storage unit 14 recognizes the division line whose absolute value of division line distance K0 is the smallest among the division lines whose division line distance K0 are negative values, as the right first division line R1 corresponding to the right side division line of the own lane; recognizes the division line whose absolute value of division line distance K0 is the second smallest, as the right second division line R2; and recognizes the division line whose absolute value of division line distance K0 is the third smallest, as the right third division line R3.

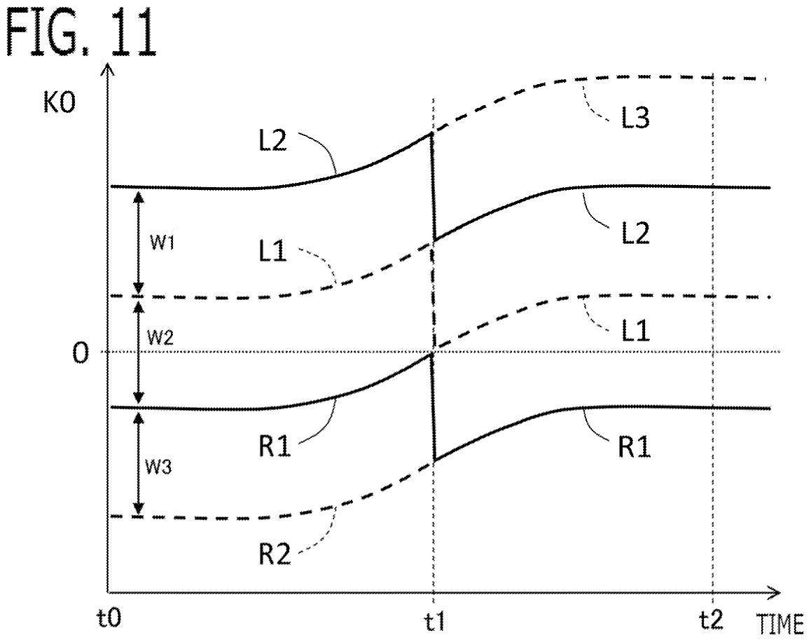

FIG. 10 and FIG. 11 show a behavior when the own vehicle which was traveling in the middle lane of the three lanes on one side carries out a lane change to the right side lane. FIG. 10 shows the behavior of the own vehicle on the basis of the road, and FIG. 11 shows the time chart of the division line distance K0 of each division line. At the time t0, the own vehicle is traveling in the middle lane, the division line distance K0 of the left first division line L1 and the division line distance K0 of the right first division line R1 become a half of the lane width W2 of the middle lane. After that, since the lane change to right side was started, the absolute value of the division line distance K0 of the right first division line R1 is decreasing, and the division line distance K0 of the left first division line L1 is increasing.

Then, at the time t1, the division line distance K0 of the division line which was recognized as the right first division line R1 becomes a positive value and becomes the division line whose division line distance K0 is the smallest among the division lines whose division line distances K0 are positive values, and it is recognized as the left first division line L1. At the time t1, the division line distance K0 of the division line which was recognized as the left first division line L1 becomes the division line whose division line distance K0 is the second smallest among the division lines whose division line distances K0 are positive values, and it is recognized as the left second division line L2. At the time t1, the division line distance K0 of the division line which was recognized as the right second division line R2 becomes the division line whose absolute value of division line distance K0 is the smallest among the division lines whose division line distances K0 are negative values, and it is recognized as the right first division line R1.

### <Change of Correspondence Relation According to Crossing Determination of Division Line>

In the present embodiment, the own lane determination storage unit 14 determines whether or not the own vehicle crossed the division line, based on the division line information of the each division line; and changes the own lane into a lane after crossing the division line, and changes the correspondence relation between the own lane and the each division line, when determining that the own vehicle crossed.

### <Crossing Determination of Division Line on the Right Side>

For example, as shown in the next equation, (condition 1) when a deviation ΔK0R1 between the division line distance K0R1_old of the right first division line R1 acquired last time and the division line distance K0R1 of the right first division line R1 acquired this time becomes within a range corresponding to the lane width when performing the lane change to the right side lane; or (condition 2) when the deviation ΔK0L1 between the division line distance K0L1_old of the left first division line L1 acquired last time and the division line distance K0L1 of the left first division line L1 acquired this time becomes within a range corresponding to the lane width when performing the lane change to the right side lane, the own lane determination storage unit 14 determines that the own vehicle crossed the division line on the right side and changed lane to the right side lane.

ΔK0R1=K0R1−K0R1_old

ΔK0L1=K0L1−K0L1_old

When (condition 1) −W3−ΔW<=ΔK0R1<=−W3+ΔW

or

(condition 2) −W2−ΔW<=ΔK0L1<=−W2+ΔW (5)

is established,

it is determined that the own vehicle changed lanes to the right side lane.

The range corresponding to the lane width of the condition 1 is set to −W3−ΔW to −W3+ΔW. W3 is set to the lane width of the lane which is a destination for right side lane change, for example, it is set to a deviation between the division line distance K0R1_old of the right first division line R1 acquired last time, and the division line distance K0R2_old of the right second division line R2 acquired last time. The range corresponding to the lane width of the condition 2 is set to −W2−ΔW to −W2+ΔW. W2 is set to the lane width of the own lane before lane change, for example, it is set to a deviation between the division line distance K0L1_old of the left first division line L1 acquired last time, and the division line distance K0R1_old of the right first division line R1 acquired last time. ΔW is set to a prescribed value, such as 0.1 m, or it is set to a prescribed ratio, such as 10%, of the lane width W3 or the lane width W2.

Furthermore, as shown in the next equation, (condition 1) when the division line distance K0R1_old of the right first division line R1 acquired last time is closer to 0 than a determination value ΔWm, and a deviation ΔK0R1 between the division line distance K0R1_old of the right first division line R1 acquired last time and the division line distance K0R1 of the right first division line R1 acquired this time becomes within a range corresponding to a lane width when performing the lane change to the right side; or (condition 2) when the division line distance K0L1_old of the left first division line L1 acquired last time is closer to the lane width W2 than the determination value ΔWm, and a deviation ΔK0L1 between the division line distance K0L1_old of the left first division line L1 acquired last time and the division line distance K0L1 of the left first division line L1 acquired this time becomes within a range corresponding to the lane width when performing the lane change to the right side, the own lane determination storage unit 14 may determine that the own vehicle crossed the division line on the right side, and changed lane to the right side lane.

ΔK0R1=K0R1−K0R1_old

ΔK0L1=K0L1−K0L1_old

When (Condition 1) −ΔWm<=K0R1_old<=ΔWm, and −W3−ΔW<=ΔK0R1<=−W3+ΔW

or

(Condition 2) W2−ΔWm<=K0L1_old<=W2+ΔWm, and −W2−ΔW<=ΔK0L1<=−W2+ΔW (6)

is established,

it is determined that the own vehicle changed lane to the right side lane.

ΔWm may be set to the same value as ΔW, or may be set to a different value. Alternatively, a speed at which the own vehicle approaches the division line may be calculated based on the vehicle speed and the division line angle K1 of the corresponding division line, and ΔWm and ΔW may be set according to the approach speed to the division line. For example, if the approach speed to the division line is large, a change amount of the division line distance K0 during the calculation period becomes large, the division line distance K0 changes beyond the determination range, before and after crossing the division line, and the crossing determination of the division line may not be performed. However, the crossing of the division line can be certainly determined by changing the determination range according to the approach speed to the division line.

### <Crossing Determination of Division Line on Left Side>

As shown in the next equation, (condition 3) when a deviation ΔK0L1 between the division line distance K0L1_old of the left first division line L1 acquired last time and the division line distance K0L1 of the left first division line L1 acquired this time becomes within a range corresponding to the lane width when performing the lane change to the left side lane; or (condition 4) when a deviation ΔK0R1 between the division line distance K0R1_old of the right first division line R1 acquired last time and the division line distance K0R1 of the right first division line R1 acquired this time becomes within a range corresponding to the lane width when performing the lane change to the left side lane, the own lane determination storage unit 14 determines that the own vehicle crossed the division line on the left side and changed lane to the left side lane.

ΔK0L1=K0L1−K0L1_old

ΔK0R1=K0R1−K0R1_old

When (Condition 3) W1−ΔW<=ΔK0L1<=W1+ΔW

or

(Condition 4) W2−ΔW<=ΔK0R1<=W2+ΔW (7)

is established,

it is determined that the own vehicle changed lane to the left side lane.

The range corresponding to the lane width of the condition 3 is set to from W1−ΔW to W1+ΔW. W1 is set to the lane width of the lane which is a destination for left side lane change, for example, it is set to a deviation between the division line distance K0L2_old of the left second division line L2 acquired last time, and the division line distance K0L1_old of the left first division line L1 acquired last time. The range corresponding to the lane width of the condition 4 is set to from W2−ΔW to W2+ΔW. ΔW is set to a prescribed value, such as 0.1 m, or it is set to a prescribed ratio, such as 10%, of the lane width W3 or the lane width W2.

Furthermore, as shown in the next equation, (condition 3) when the division line distance K0L1_old of the left first division line L1 acquired last time is closer to 0 than the determination value ΔWm, and a deviation ΔK0L1 between the division line distance K0L1_old of the left first division line L1 acquired last time and the division line distance K0L1 of the left first division line L1 acquired this time becomes within a range corresponding to the lane width when performing the lane change to the left side; or (condition 4) when the division line distance K0R1_old of the right first division line R1 acquired last time is closer to the lane width W2 than the determination value ΔWm, and a deviation ΔK0R1 between the division line distance K0R1_old of the right first division line R1 acquired last time and the division line distance K0R1 of the right first division line R1 acquired this time becomes within a range corresponding to the lane width when performing the lane change to the left side, the own lane determination storage unit 14 may determine that the own vehicle crossed the division line on the left side, and changed lane to the left side lane.

ΔK0L1=K0L1−K0L1_old

ΔK0R1=K0R1−K0R1_old

When (Condition 3) −ΔWm<=K0L1_old<=ΔWm, and W1−ΔW<=ΔK0L1<=W1+ΔW

or

(Condition 4) −W2−ΔWm<=K0R1_old<=−W2+ΔWm, and W2−ΔW<=ΔK0R1<=W2+ΔW (8)

is established,

it is determined that the own vehicle changed lane to the left side lane.

When both of the condition 1 and the condition 2 are established, the own lane determination storage unit 14 may determine that the own vehicle crossed the division line on the right side, and changed lane to the right side lane. Similarly, when both of the condition 3 and the condition 4 are established, the own lane determination storage unit 14 may determine that the own vehicle crossed the division line on the left side, and changed lane to the left side lane. However, when one division line is not detected, the crossing determination of the division line cannot be performed. In this case, although the correspondence relation between the own lane and the each division line is not changed, a processing corresponding to the deviation or the variance described below becoming large is performed. As the result, the vehicle control can be prevented from being performed based on the division line information which changed suddenly.

In the case where it is determined that the own vehicle crossed the division line on the right side and changed lane to the right side lane when the condition 1 or the condition 2 is established, when the condition 1 and the condition 2 are not actually established at the same time due to some factor, there is a possibility that change of the division line information of one which was delayed in the switching timing may not be performed appropriately. However, processing for dealing with the case where the deviation or the variance becomes large is performed, and the inappropriate division line information can be prevented from being used. As the result, the vehicle control can be prevented from being performed based on the inappropriate division line information. The same applies to determination of the condition 3 and the condition 4.

### <Storage of Division Line Information, and Change by Crossing Determination>

As mentioned above, the own lane determination storage unit 14 stores one or both (in this example, both) of the division line information and the division line information of current position basis, at the plurality of time points of the each division line, by correlating with the correspondence relation between the own lane and the each division line which were determined this time. In the present embodiment, the own lane determination storage unit 14 stores one or both of the division line information and the division line information of current position basis, at the plurality of time points of the each division line, by correlating with the identification information of each division line on the basis of the own lane. As the identification information of each division line on the basis of the own lane, the left first division line L1, the right first division line R1, the left second division line L2, the right second division line R2, the left third division line L3, the right third division line R3, and the like mentioned above are used.

For example, as shown in FIG. 8 and FIG. 9, the own lane determination storage unit 14 stores the division line information (K0 to K3) and the division line information of current position basis (K0p to K3p) of each division line acquired at each time point to the rewritable storage apparatus 91 such as RAM, by correlating with identification information L1, R1, L2, R2 of each division line and a history number n indicating acquisition time point (n=1, 2, . . . , N-1, N). When there is identification information of division line where the division line information is not acquired, the division line information of its identification information is made blank.

The history number n of the division line information acquired this time is set to 1, and the history number n is increased one by one, as the division line information becomes old. That is to say, the division line information acquired this time is stored by correlating with the history number n=1, and the history number n of the division line information already stored is increased by one. The number of the plurality of time points to be stored, that is, the maximum number N of the history number n, is set to a prescribed value, for example, 10. Accordingly, the division line information older than the history number n=10 is deleted.

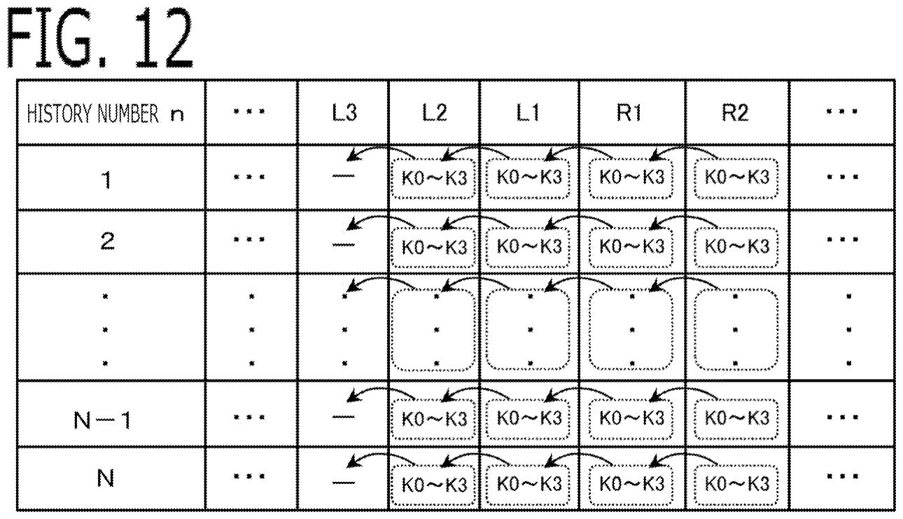

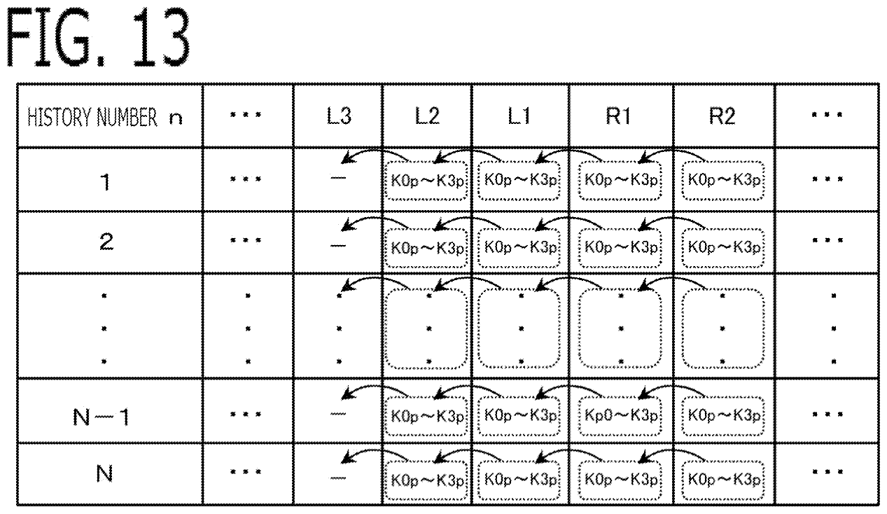

When determining that the correspondence relation between the own lane and the each division line changed, the own lane determination storage unit 14 changes one or both (in this example, both) of the division line information and the division line information of current position basis at the plurality of time points of the each division line which were stored by correlating with the identification information of the each division line, among the identification information of the each division line, so as to correspond to the correspondence relation after change. As shown in FIG. 12 and FIG. 13, for example, when it is determined that the own vehicle crossed the division line on the right side of the own lane, the division line information and the division line information of current position basis of the each division line which were stored at the plurality of past time points are changed to the division line information of the division line on the just left side.

As the maximum number N of the stored time points increases, the estimation division line information described below is stabilized, but the storage area and the computation load increase. If the maximum. number N of the stored time points increases too much, the old division line information obtained by detecting the division line in the vicinity of the current position at the past position of the own vehicle is used, and accuracy of the estimation division line information is deteriorated. It is not appropriate to use the division line information ahead more than the maximum distances (for example, 100 m) capable of detecting the division line in front of the own vehicle according to the performance of the camera, and the like. Accuracy of the division line information detected at the past position of the own vehicle exceeding the maximum distance is deteriorated. Accordingly, the maximum number N of the stored time points may be set to an appropriate number capable of obtaining estimation accuracy of the estimation division line information, considering the acquisition period, the vehicle speed, the detection maximum distance of camera, and the like.

On the other hand, even when it is not exceeded the detection maximum distance of camera, for example, when visibility is bad due to a sharp curve and the like, or when an inclination between the own vehicle and the division line is large and the photographing area of the division line becomes narrow, or when the division line is hidden by the preceding vehicle, accuracy of the division line information newer than the time point corresponding to the detection maximum distance of camera is also deteriorated.

### <Change of Maximum Number of Storage Time Point According to Detection State of Division Line>

Accordingly, the own lane determination storage unit 14 may change the maximum number N of the plurality of stored time points of one or both of the division line information and the division line information of current position basis of the each division line, according to the detection state of the each division line. As the detection state of the division line becomes good, the maximum number N of stored time points is increased. As the detection state of the division line becomes bad, the maximum number N of stored time points is decreased. For example, as the detection state of the division line, the division line angle of division line K1 and the curvature of division line K2 are used. As the absolute values of the division line angle K1 and the curvature of division line K2 become large, the detection state of the division line becomes bad. As the detection state of the division line, the vehicle distance to the preceding vehicle may be detected by the camera or the radar. As the vehicle distance becomes short, the detection state of the division line becomes bad. As the detection state of the division line, the maximum recognition distance in front of the own vehicle where the division line is recognized by the camera is used. As the maximum recognition distance becomes long, the detection state of the division line becomes good. These plurality of parameters of the detection state of the division line may be used selectively, or may be used comprehensively.

### <Flowchart of Own Lane Determination Storage Processing>

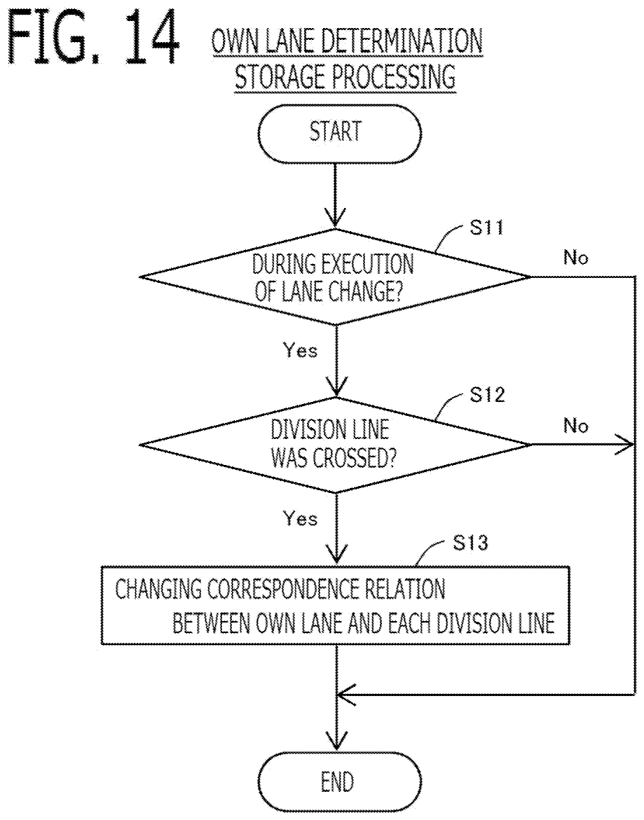

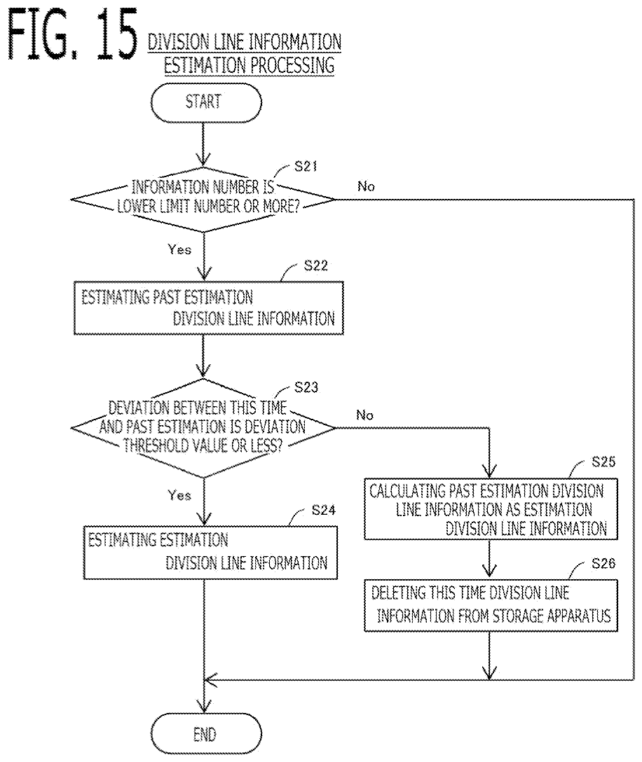

Using the flowchart of FIG. 14, the own lane determination storage processing according to the present embodiment will be explained. In the step S11, the own lane determination storage unit 14 determines whether or not the own vehicle is during execution of the lane change to the right side lane or the left side lane. When determining that it is during execution of the lane change, it advances to the step S12 and performs the crossing determination of the division line, and when determining that it is not during execution of the lane change, the own lane determination storage processing is ended.

In the present embodiment, it is assumed that the driving support system 25 which performs the lane change automatically is mounted. When the driving support system 25 determines to carry out the lane change to the right side lane or the left side lane for traveling to the destination or according to the periphery traveling state, and is executing the lane change, it is determined that it is during execution of the lane change. The driving support system 25 turns on the direction indicator corresponding to its lane change direction, when the execution of lane change is determined.

If a system which performs driving support of lane change by setting a lane change instruction of driver as a starting point is assumed, when there is a requirement of lane change of driver detected by operation of the direction indicator or other means, it is determined that it is during execution of the lane change.

Even in other than during execution of the lane change, the crossing determination of the division line may be performed. Even in the lane change and the crossing of the division line without operation of the direction indicator and the like, the crossing determination of the division line may be performed.

In the step S12, as mentioned above, the own lane determination storage unit 14 determines whether or not the own vehicle crossed the division line of the left side or the right side, based on the division line information of the each division line. When determining that it crossed the division line, it advances to the step S13, and when determining that it did not cross the division line, the own lane determination storage processing is ended.

In the step S13, as mentioned above, the own lane determination storage unit 14 changes the own lane into a lane after crossing the division line, and changes the correspondence relation between the own lane and the each division line. Then, the own lane determination storage unit 14 changes the division line information at the plurality of time points which were stored by correlating with the identification information of the each division line, among the identification information of the each division line, so as to correspond to the correspondence relation after change.

### 1-5. Division Line Information Estimation Unit 15

In the step S05 of FIG. 4, the division line information estimation unit 15 executes a division line information estimation processing (a division line information estimation step) that estimates estimation division line information which is one division line information, based on the division line information of current position basis at the plurality of time points, about each of the division line on the left side and the division line on the right side of the own lane.

Using the flowchart of FIG. 15, the division line information estimation processing according to the present embodiment will be explained. About each of the division line on the left side and the division line on the right side of the own lane, the processing of the flowchart of FIG. 15 is executed. In the following, although the division line on the left side of the own lane is explained as a representative, similar processing is performed for the division line on the right side of the own lane. In the present embodiment, similar processing is performed also for the division line of the adjacent lane.

In the step S21, the division line information estimation unit 15 determines whether or not a number of the division line information of current position basis of the division line on the left side of the own vehicle (the left first division line L1) stored in the storage apparatus 91 exists a preliminarily set lower limit number or more. When it exists the lower limit number or more, it advances to the step S22, When it does not exist the lower limit number or more, the processing is ended without estimating the estimation division line information of the division line on the left side of the own vehicle.

If the number of the division line information of current position basis used for calculation of the estimation division line information is too small, it is easily subject to influence of the detection variation of the division line information, and accuracy of the estimation division line information may become low. On the other hand, If it waits too much until the number of division line information of current position basis increases, a time lag until the estimation division line information is calculated after starting detection of the division line becomes large too much, and a difficulty occurs in control of the steering control unit 17 described below. Accordingly, the lower limit number is set to a number that accuracy of the estimation division line information is not deteriorated too much and a difficulty does not occurs in control of the steering control unit 17, for example, it is set to 5.

In the present disclosure, the division line information that the own lane and the adjacent lane can be recognized is acquired; the division line information of the adjoining division line at the plurality of time points are taken over as the division line information of the division line of the own lane even after the crossing of the division line was determined; and the division line information of current position basis of the division line of the own lane at the plurality of time points are calculated. Accordingly, even just after crossing the division line, the number of the division line information of current position basis does not decrease, and the estimation division line information can be calculated.

In the step S22, about the division line on the left side of the own vehicle (the left first division line L1), the division line information estimation unit 15 estimates the past estimation division line information which is one division line information, based on the division line information of current position basis at the plurality of time points (history number n<=2) older than this time which are stored in the storage apparatus 91. The division line information estimation unit 15 calculates the one past estimation division line information by performing an averaging processing of the division line information of current position basis at the plurality of time points older than this time. As the averaging processing, a simple averaging may be performed, or a weighted averaging may be performed. If the weighted averaging is performed, since the newer information is closer to the current state, a weight to information at newer time point is enlarged.

The division line information estimation unit 15 calculates a division line distance K0eo, a division line angle K1eo, a curvature of division line K2eo, and a curvature change rate of division line K3eo of past estimation, by performing the averaging processing of values at the plurality of time points older than this time, about each parameter of the division line distance K0p, the division line angle K1p, the curvature of division line K2p, and the curvature change rate of division line K3p of current position basis.

Then, in the step S23, the division line information estimation unit 15 determines whether or not a deviation (absolute value) between this time division line information of current position basis and the past estimation division line information of the division line on the left side of the own vehicle is less than or equal to a deviation threshold value. When determining that it is less than or equal to the deviation threshold value, it advances to the step S24, and when determining that it is not less than or equal to the deviation threshold value, it advances to the step S25.

In this way, by determining the magnitude of the deviation, detection accuracy and reliability of this time division line information can be determined on the basis of the past estimation division line information calculated based on the information at the plurality of time points older than this time.

In the present embodiment, the division line information estimation unit 15 calculates a deviation (absolute value) between this time value of current position basis and a value of past estimation, about each parameter of the division line distance K0, the division line angle K1, the curvature of division line K2, and the curvature change rate of division line K3; and determines whether or not the deviation of each parameter is less than or equal to a deviation threshold value which is set for each parameter. When there is the parameter determined not to be less than or equal to the deviation threshold value, the division line information estimation unit 15 determines that it is not less than or equal to the deviation threshold value, and advances to the step S25. When there is no parameter determined not to be less than or equal to the deviation threshold value, the division line information estimation unit 15 determines that it is less than or equal to the deviation threshold value, and advances to the step S24.

The deviation threshold value of each parameter is preliminarily set, considering the calculation period, the change of road structure, and the like. The parameters with high importance for the steering control unit 17 described below, for example, the division line distance K0, the division line angle K1, and the like are used for determination. The parameters with low importance, for example, the curvature change rate of division line K3 may not be used for determination. Alternatively, the deviation threshold value of the parameter with low importance may be set higher.

When the correspondence relation between the own lane and the each division line which was determined by the own lane determination storage unit 14 changed, the division line information estimation unit 15 may decrease the deviation threshold value rather than when it is not changing. When the crossing of the division line was determined, the division line information is changed among the identification information of each division line. Accordingly, the division line information may become discontinuous due to the determination error. It becomes easy to exclude the division line information which became discontinuous, by decreasing the deviation threshold value.

In the step S24, about the division line on the left side of the own lane (the left first division line L1), the division line information estimation unit 15 estimates one estimation division line information, based on the division line information of current position basis at the plurality of time points including this time which are stored in the storage apparatus 91. The division line information estimation unit 15 calculates the one estimation division line information, by performing an averaging processing of the division line information of current position basis at the plurality of time points including this time. As the averaging processing, a simple averaging may be performed, or a weighted averaging may be performed. If the weighted averaging is performed, since the newer information is closer to the current state, a weight to information at newer time point is enlarged.

In the present embodiment, the division line information estimation unit 15 calculates a division line distance K0e, a division line angle K1e, a curvature of division line K2e, and a curvature change rate of division line K3e of estimation, by performing the averaging processing of the values at the plurality of time points including this time, about each parameter of the division line distance K0p, the division line angle K1p, the curvature of division line K2p, and the curvature change rate of division line K3p of current position basis.

In this way, when determining that the detection accuracy of the division line information acquired this time is not bad, the estimation division line information is calculated including the division line information of current position basis acquired this time, this time information of the division line is reflected, and estimation accuracy can be improved.

In the step S25, the division line information estimation unit 15 calculates the past estimation division line information as the estimation division line information. That is to say, this time division line information of current position basis whose detection accuracy is bad is excluded, and the estimation division line information is estimated based on the division line information of current position basis at the plurality of time points older than this time.

In this way, when determining that the detection accuracy of this time division line information is bad, estimation accuracy can be prevented from being deteriorated, by excluding this time division line information and calculating the estimation division line information.

In the step S26, the division line information estimation unit 15 deletes the division line information which correspond to this time division line information of current position basis of the division line on the left side of the own lane (the left first division line L1) and are stored by the own lane determination storage unit 14, from the storage apparatus 91. The division line information estimation unit 15 deletes this time division line information of current position basis of the division line on the left side of the own lane (the left first division line L1), from the storage apparatus 91.

According to this configuration, since the division line information which is determined that detection accuracy is bad is deleted from the storage apparatus 91, in the calculation on and after next time, it can avoid using the division line information whose detection accuracy is bad, and estimation accuracy of the estimation division line information can be improved.

In the above, the case where processing is performed about the division line on the left side of the own lane (the left first division line L1) was explained as the example. Also about the division line on the right side of the own lane (the right first division line R1), similar processing of the flowchart of FIG. 15 is performed. In the present embodiment, similar processing is performed also about each division line of adjacent lane.

### 1-6. Traveling Lane Recognition Unit 16

In the step S06 of FIG. 4, the traveling lane recognition unit 16 executes a traveling lane recognition processing (a traveling lane recognition step) that recognizes the positional relationship of the own lane with respect to the own vehicle, based on the estimation division line information of each of the division line on the left side and the division line on the right side of the own lane. In the present embodiment, the traveling lane recognition unit 16 also recognizes the positional relationship of the adjacent lane with respect to the own vehicle, based on the estimation division line information of the division line of the adjacent lane. The recognized positional relationship (the estimation division line information) of the own lane and the adjacent lane with respect to the own vehicle is transmitted to the steering control unit 17, the driving support system 25, and the like which are described below. It may be transmitted to the apparatus outside the vehicle.

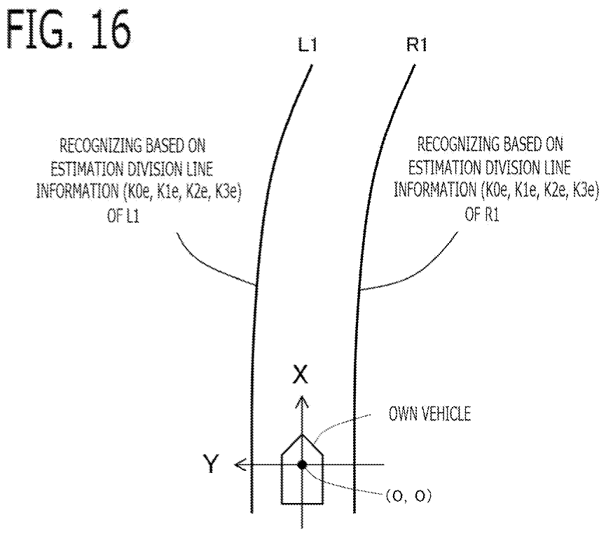

In the present embodiment, as shown in FIG. 16, the traveling lane recognition unit 16 recognizes the shape of the division line on the left side of the own vehicle in the own vehicle coordinate system corresponding to the current position of the own vehicle, based on the division line distance K0e, the division line angle K1e, the curvature of division line K2e, and the curvature change rate of division line K3e of estimation of the division line on the left side of the own lane (the left first division line L1); and recognizes the shape of the division line on the right side of the own vehicle, based on the division line distance K0e, the division line angle K1e, the curvature of division line K2e, and the curvature change rate of division line K3e of estimation of the division line on the right side of the own lane (the right first division line R1).

### 1-7. Steering Control Unit 17

The steering control unit 17 executes a steering control processing (a steering control step) that performs one or both of a steering control which controls a steering angle of wheels, and a lane deviation informing which informs deviation of the own vehicle from the own lane, to the driver, based on the positional relationship of the own lane with respect to the own vehicle which was recognized by the traveling lane recognition unit 16.

### <Steering Control>

When performing a lane keeping control, the steering control unit 17 calculates a command value of the steering angle of wheels which makes the own vehicle keep and travel the current own lane, based on the positional relationship of the own lane with respect to the own vehicle and the vehicle speed; and transmits it to the steering apparatus 24. When performing a lane change control, the steering control unit 17 calculates the command value of the steering angle of wheels which makes the own vehicle change lane, based on the positional relationship of the own lane and the adjacent lane with respect to the own vehicle, the target travel route with respect to the own lane and the adjacent lane, and the vehicle speed; and transmits it to the steering apparatus 24. The steering control unit 17 may perform the lane keeping control or the lane change control according to the instruction of the lane keeping or the lane change determined by the driving support system 25 mentioned above; or may perform the lane keeping control or the lane change control according to the instructions of the lane keeping or the lane change from the driver. The lane keeping control or the lane change control may be provided as a part of automatic driving function of the automatic driving vehicle.

The steering apparatus 24 is an electric power steering apparatus, and manipulates the steering angle of wheels by a driving force of an electric motor. The steering apparatus 24 performs driving control of the electric motor so that an actual steering angle follows the command value of the steering angle.

### <Lane Deviation Informing>

The steering control unit 17 informs deviation of the own vehicle from the own lane to the driver via the informing device, when determining that there is possibility that the own vehicle deviate from the own lane, based on the positional relationship of the own lane with respect to the own vehicle, the vehicle speed, and the like. The informing device is a loudspeaker, a display, a vibrator, and the like.

### Summary of Embodiment 1

According to the traveling lane recognition apparatus and the traveling lane recognition method of Embodiment 1, the division line information of one or a plurality of division lines which are recognizable in front of the own vehicle and include the own lane and the adjacent lane are recognized, and the correspondence relation between the own lane and the each division line is determined. Then, the division line information at the plurality of time points of the each division line which were acquired at the plurality of time points of this time and past are stored by correlating with the correspondence relation. Accordingly, not only the division line information of the own lane but also the division line information of the adjacent lane are stored and accumulated.

Then, also in the case where the division line of the own lane is changed by crossing the division line with the lane change, by changing the correspondence relation between the own lane and the each division line, the division line information of the adjacent lane detected in the past is changed into the division line information of the own lane, the division line information is converted into the division line information of current position basis, and the estimation division line information of the own lane can be estimated. Accordingly, even when the division line of the own lane is changed by the lane change, the estimation division line information of the own lane can be calculated continuously without interruption, and the positional relationship of the own lane with respect to the own vehicle can be recognized.

Since, in the case of changing the division line, the division line information at the plurality of past time points which are stored about the division line of the adjacent lane are used, the estimation accuracy of the estimation division line information can be improved more than when only the division line information of the own lane acquired this time is used.

The division line information of current position basis used for estimation of the estimation division line information are the division line information on the basis of the current position of the own vehicle obtained by converting the division line information acquired in the past based on the vehicle movement information from the acquisition time point to the current time point. Accordingly, the division line information of current position basis at the plurality of time points in the each division line become equivalent information with each other, if the each division line information can be detected with good accuracy. Accordingly, by estimating the one estimation division line information based on the division line information of current position basis at the plurality of time points, the influence of detection error can be reduced more than when only the division line information acquired this time is used, and accuracy can be improved.

Also in the case where the shape of the division line of the adjacent lane is different from the shape of the division line of the own lane at the junction point and the branch point of road, and the like, the division line information of the adjacent lane at the plurality of past time points are used after changing the division line. Accordingly, the estimation division line information of the adjacent lane whose shape is different from the own lane can be estimated with good accuracy. Since the division line distance K0, the division line angle K1, the curvature of division line K2, and the curvature change rate of division line K3 are used as the division line information, the difference in shape of each division line can be estimated in detail with good accuracy. Or, although the recognizability of the division line of the own lane is not good due to existence of the preceding vehicle, visibility of the division line, and the like, there is the case where the recognizability of the division line of the adjacent lane is good. In this case, after changing the division line, the estimation division line information of the own lane can be estimated with good accuracy using the past division line information of the adjacent lane with good recognizability.

Therefore, regardless of the presence or absence of change of the division line of the own lane by the lane change, the estimation division line information of the own lane can be continuously estimated with good accuracy, and the positional relationship of the own lane with respect to the own vehicle can be recognized with good accuracy.

### 2. Embodiment 2

Next, the traveling lane recognition apparatus 10 and the traveling lane recognition method according to Embodiment 2 will be explained. The explanation for constituent parts the same as those in Embodiment 1 will be omitted. The basic configuration of the traveling lane recognition apparatus 10 and the traveling lane recognition method according to the present embodiment is the same as those of Embodiment 1. Embodiment 2 is different from Embodiment 1 in a part of processing of the division line information estimation unit 15.

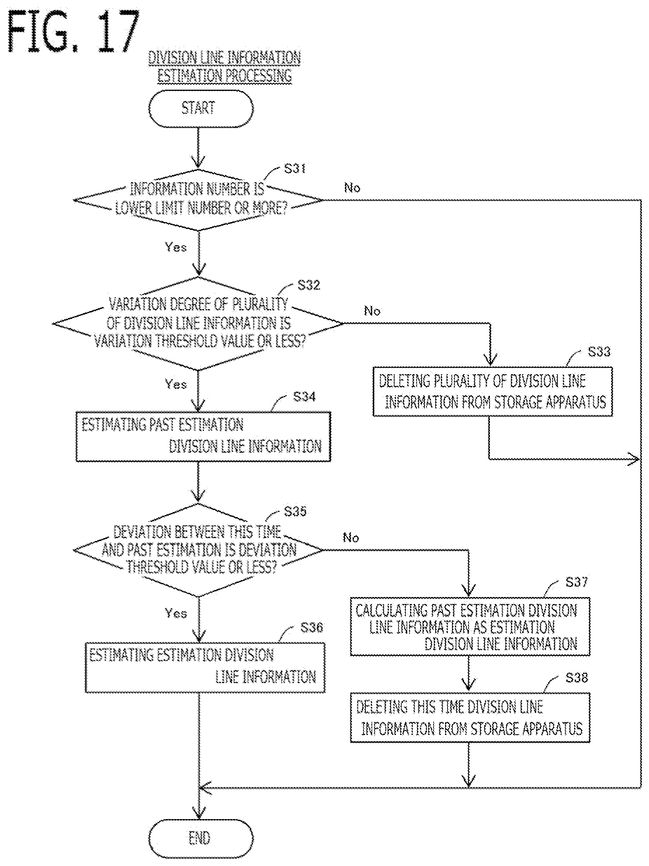

The division line information estimation processing according to the present embodiment will be explained using the flowchart of FIG. 17. About each of the division line on the left side and the division line on the right side of the own lane, the processing of the flowchart of FIG. 17 is executed. In the following, although the division line on the left side of the own lane is explained as a representative, similar processing is performed for the division line on the right side of the own lane. In the present embodiment, similar processing is performed also about division line of the adjacent lane.

In the step S31, similarly to the step S21 of FIG. 15 of Embodiment 1, the division line information estimation unit 15 determines whether or not a number of the division line information of current position basis of the division line on the left side of the own vehicle (the left first division line L1) stored in the storage apparatus 91 exists a preliminarily set lower limit number or more. When it exists the lower limit number or more, it advances to the step S32, and when it does not exist the lower limit number or more, the processing is ended without estimating the estimation division line information of the division line on the left side of the own vehicle.

In the step S32, the division line information estimation unit 15 calculates a variation degree of the division line information of current position basis at the plurality of time points of this time and the past, about the division line on the left side of the own lane (the left first division line L1); and determines whether or not the variation degree is less than or equal to a variation threshold value. When determining that the variation degree is not less than or equal to the variation threshold value, the division line information estimation unit 15 advances to the step S33 and deletes the division line information at the plurality of time points of this time and the past of the division line on the left side of the own lane (the left first division line L1) stored in the storage apparatus 91, and ends processing without estimating the estimation division line information. On the other hand, when determining that the variation degree is less than or equal to the variation threshold value, the division line information estimation unit 35 advances to the step S34.

As the variation degree, a variance is calculated. As the variation degree, a standard deviation may be calculated. However, since the standard deviation requires a square root calculation, the calculation processing load can be reduced by using the variance.

In the present embodiment, about each of the division line distance K0, the division line angle K1, the curvature of division line K2, and the curvature change rate of division line K3, the division line information estimation unit 15 calculates the variation degree DK0p, DK1p, DK2p, DK3p of values at the plurality of time points of this time and the past, about each parameter of the division line distance K0p, the division line angle K1p, the curvature of division line K2p, and the curvature change rate of division line K3p of current position basis; and determines whether or not the variation degree of each parameter is less than or equal to the variation threshold value which is set about each parameter. When there is the parameter determined not to be less than or equal to the variation threshold value, the division line information estimation unit 15 determines that it is not less than or equal to the variation threshold value, and advances to the step S33. When there is no parameter determined not to be less than or equal to the variation threshold value, the division line information estimation unit 15 determines that it is less than or equal to the variation threshold value, and advances to the step S34.

Since the plurality of stored division line information are deleted when it is determined not to be less than or equal to the variation threshold value, a time lag until the estimation division line information is estimated and outputted in the next time occurs. Accordingly, a setting value of the variation threshold value may be a value determined that it is less than or equal to the variation threshold value in the normal condition, and a value determined that it is not less than or equal to the variation threshold value in the abnormal condition where the detecting state is deteriorated and erroneous detection occurs frequently.

The parameters with high importance for the steering control unit 17 described below, for example, the division line distance K0, the division line angle K1, and the like are used for determination. The parameters with low importance, for example, the curvature change rate of division line K3 may not be used for determination. Alternatively, the variation threshold value of the parameter with low importance may be set higher.

When the correspondence relation between the own lane and the each division line which was determined by the own lane determination storage unit 14 changes, the division line information estimation unit 15 may decrease the variation threshold value than when the correspondence relation does not change. Since the division line information is moved among the identification information of each division line when the crossing of the division line was determined, the division line information may become discontinuous due to the determination error. By decreasing the variation threshold value, it becomes easy to exclude the division line information which became discontinuous.

Since the processing from the step S34 to the step S38 which is executed when it is determined to be less than or equal to the variation threshold value is the same as the processing from the step S21 to the step S28 of FIG. 15 of Embodiment 1, explanation is omitted.

### Summary of Embodiment 2

According to the traveling lane recognition apparatus and the traveling lane recognition method of Embodiment 2, the plurality of division line information of the division line whose detection state is bad and whose variation degree is larger than the variation threshold value are deleted, and it can avoid estimating inaccurate estimation division line information. Accordingly, the positional relationship of the own lane with respect to the own vehicle can be prevented from being recognized using inaccurate estimation division line information.

### Other Embodiments

(1) The traveling lane recognition apparatus explained above can be applied also to a traveling lane recognition system which is constructed as a system, by appropriately combining a navigation apparatus such as PND (Portable Navigation Device), a communication terminal device including a portable terminal device such as a mobile phone, a smart phone, and a tablet, a function of application installed in these, and a server. In this case, each function or each component of the traveling lane recognition apparatus explained above may be distributedly arranged to each apparatus which constructs the system, or may be collectively arranged to any one of apparatuses.

(2) In each of the above-mentioned Embodiments, there has been explained the case where the division line information conversion unit 13 converts the division line information of each division line acquired at each time point, into the division line information of current position basis of the each division line on the basis of the current position of the own vehicle, based on the vehicle movement information from the acquisition time point to the current time point. However, embodiments of the present disclosure are not limited to the foregoing case. That is to say, the division line information conversion unit 13 may convert the division line information of current position basis at the plurality of time points of the each division line calculated at the last time calculation period, into the division line information of current position basis at the plurality of time points of the each division line on the basis of the current position of the own vehicle, based on the vehicle movement information from the last time acquisition time point to the current time point.

(3) In each of the above-mentioned Embodiments, there has been explained the case where the own lane determination storage unit 14 stores both of the division line information and the division line information of current position basis, at the plurality of time points of the each division line, by correlating with the correspondence relation between the own lane and the each division line which was determined this time; and when determining that the correspondence relation between the own lane and the each division line changed, changes both of the division line information and the division line information of current position basis at the plurality of time points of the each division line which were stored by correlating with the identification information of the each division line, among the identification information of the each division line, so as to correspond to the correspondence relation after change. However, embodiments of the present disclosure are not limited to the foregoing case. That is to say, the own lane determination storage unit 14 may store one of the division line information and the division line information of current position basis, at the plurality of time points of the each division line, by correlating with the correspondence relation between the own lane and the each division line which was determined this time. When determining that the correspondence relation between the own lane and the each division line changed, the own lane determination storage unit 14 changes one of the division line information and the division line information of current position basis at the plurality of time points of the each division line which were stored by correlating with the identification information of the each division line, among the identification information of the each division line, so as to correspond to the correspondence relation after change.

For example, the own lane determination storage unit 14 stores the division line information of current position basis at the plurality of time points of the each division line, by correlating with the correspondence relation between the own lane and the each division line which was determined this time. When determining that the correspondence relation between the own lane and the each division line changed, the own lane determination storage unit 14 may change the division line information of current position basis at the plurality of time points of the each division line which were stored by correlating with the identification information of the each division line, among the identification information of the each division line, so as to correspond to the correspondence relation after change. In this case, the division line information conversion unit 13 may convert the division line information of current position basis at the plurality of time points of the each division line calculated and stored at the last time calculation period, into the division line information of current position basis at the plurality of time points of the each division line on the basis of the current position of the own vehicle, based on the vehicle movement information from the last time acquisition time point to the current time point. The own lane determination storage unit 14 may store the division line information of current position basis at the plurality of time points of the each division line together with the division line information of the each division line acquired this time.

Alternatively, the own lane determination storage unit 14 may store the division line information at the plurality of time points of the each division line, by correlating with the correspondence relation between the own lane and the each division line which was determined this time; and when determining that the correspondence relation between the own lane and the each division line changed, changes the division line information at the plurality of time points of the each division line which were stored by correlating with the identification information of the each division line, among the identification information of the each division line, so as to correspond to the correspondence relation after change. In this case, after the own lane determination storage unit 14 changes the division line information at the plurality of time points of the each division line, among the identification information of division line, the division line information conversion unit 13 may convert a plurality of past division line information of the each division line acquired at the plurality of time points, into a plurality of division line information of current position basis of the each division line on the basis of the current position of the own vehicle, based on the vehicle movement information. In this case, although the division line information of current position basis is stored in the storage apparatus, such as RAM, and is used for processing of the division line information estimation unit 15, the storage for using in the next calculation period becomes unnecessary unlike each of above embodiments.

Although the present disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments. It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### REFERENCE SIGNS LIST

10 Traveling Lane Recognition Apparatus, 11 Division Line Information Acquisition Unit, 12 Vehicle Movement Acquisition Unit, 13 Division Line Information Conversion Unit, 14 Own Lane Determination Storage Unit, 15 Division Line Information Estimation Unit, 16 Traveling Lane Recognition Unit, 17 Steering Control Unit, K0 Division line distance, K1 Division line angle, K2 Curvature of division line, Δθ Change amount of yaw angle, ΔX Moving distance in front direction, ΔY Moving distance in lateral direction

1. A traveling lane recognition apparatus comprising at least one processor configured to implement:
a division line information acquisitor that acquires division line information regarding position and shape of each division line on a basis of a position of an own vehicle, about division lines of one or a plurality of lanes which are recognizable in front of the own vehicle and include an own lane which is a lane where the own vehicle is traveling, and a lane adjacent to the own lane;
a vehicle movement acquisitor that acquires vehicle movement information regarding movement of the own vehicle from an acquisition time point of the division line information to a current time point;
a division line information converter that converts the division line information at a plurality of time points of the each division line, into division line information of current position basis on a basis of a current position of the own vehicle at the plurality of time points of the each division line, based on the vehicle movement information;
an own lane determination storager that determines a correspondence relation between the own lane and the each division line, based on the division line information of the each division line, and stores one or both of the division line information and the division line information of current position basis, at the plurality of time points of the each division line, by correlating with the correspondence relation;
a division line information estimator that estimates estimation division line information which is one division line information, based on the division line information of current position basis at the plurality of time points, about each of a division line on a left side and a division line on a right side of the own lane; and
a traveling lane recognizer that recognizes a positional relationship of the own lane with respect to the own vehicle, based on the estimation division line information of each of the division line on the left side and the division line on the right side of the own lane.

2. The traveling lane recognition apparatus according to claim 1,
wherein the own lane determination storager determines whether or not the own vehicle crossed the division line, based on the division line information of the each division line; and
changes the own lane into a lane after crossing the division line, and changes the correspondence relation between the own lane and the each division line, when determining that the own vehicle crossed.

3. The traveling lane recognition apparatus according to claim 2,
wherein the division line information acquisitor acquires information including a division line distance which is a distance between a part of the division line located in a lateral direction of the own vehicle and the own vehicle, as the division line information of the each division line; and
wherein, when a deviation between the division line distance of the division line on the right side of the own lane acquired last time and the division line distance of the division line on the right side of the own lane acquired this time becomes within a range corresponding to a lane width when performing a lane change to the right side, or
when a deviation between the division line distance of the division line on the left side of the own lane acquired last time and the division line distance of the division line on the left side of the own lane acquired this time becomes within a range corresponding to a lane width when performing the lane change to the right side,
the own lane determination storager determines that the own vehicle crossed the division line on the right side of the own lane; and
when a deviation between the division line distance of the division line on the left side of the own lane acquired last time and the division line distance of the division line on the left side of the own lane acquired this time becomes within a range corresponding to a lane width when performing the lane change to the left side, or
when a deviation between the division line distance of the division line on the right side of the own lane acquired last time and the division line distance of the division line on the right side of the own lane acquired this time becomes within a range corresponding to a lane width when performing the lane change to the left side,
the own lane determination storager determines that the own vehicle crossed the division line on the left side of the own lane.

4. The traveling lane recognition apparatus according to claim 2,
wherein the division line information acquisitor acquires information including a division line distance which is a distance between a part of the division line located in a lateral direction of the own vehicle and the own vehicle, as the division line information of the each division line; and
wherein, when the division line distance of the division line on the right side of the own lane acquired last time is closer to 0 than a determination value, and a deviation between the division line distance of the division line on the right side of the own lane acquired last time and the division line distance of the division line on the right side of the own lane acquired this time becomes within a range corresponding to a lane width when performing a lane change to the right side, or
when the division line distance of the division line on the left side of the own lane acquired last time is closer to the lane width than a determination value, and a deviation between the division line distance of the division line on the left side of the own lane acquired last time and the division line distance of the division line on the left side of the own lane acquired this time becomes within a range corresponding to a lane width when performing the lane change to the right side,
the own lane determination storager determines that the own vehicle crossed the division line on the right side of the own lane; and
when the division line distance of the division line on the left side of the own lane acquired last time is closer to 0 than a determination value, and the deviation between the division line distance of the division line on the left side of the own lane acquired last time and the division line distance of the division line on the left side of the own lane acquired this time becomes within a range corresponding to a lane width when performing the lane change to the left side, or
when the division line distance of the division line on the right side of the own lane acquired last time is closer to the lane width than a determination value, and the deviation between the division line distance of the division line on the right side of the own lane acquired last time and the division line distance of the division line on the right side of the own lane acquired this time becomes within a range corresponding to a lane width when performing the lane change to the left side,
the own lane determination storager determines that the own vehicle crossed the division line on the left side of the own lane.

5. The traveling lane recognition apparatus according to claim 1,
wherein the own lane determination storager stores one or both of the division line information and the division line information of current position basis, at the plurality of time points of the each division line, by correlating with identification information of the each division line on a basis of the own lane; and
when determining that the correspondence relation between the own lane and the each division line changed, changes one or both of the division line information and the division line information of current position basis at the plurality of time points of the each division line which were stored by correlating with the identification information of the each division line, among the identification information of the each division line, so as to correspond to the correspondence relation after change.

6. The traveling lane recognition apparatus according to claim 1,
wherein the own lane determination storager changes a maximum number of the plurality of time points that one or both of the division line information and the division line information of current position basis of the each division line are stored, according to a detection state of the each division line.

7. The traveling lane recognition apparatus according to claim 1,
wherein the division line information acquisitor acquires, as the division line information of the each division line, information including a division line distance which is a distance between the own vehicle and a part of the division line located in a lateral direction of the own vehicle, a division line angle which is an inclination of the part of the division line located in the lateral direction of the own vehicle with respect to a front direction of the own vehicle, and a curvature of the division line.

8. The traveling lane recognition apparatus according to claim 7,
wherein the vehicle movement acquisitor acquires moving distances in the front direction and the lateral direction of the own vehicle, and a change amount of yaw angle, on a basis of the own vehicle at an acquisition time point of the division line information, and
wherein the division line information converter converts the division line distance, the division line angle, and the curvature of division line, as the division line information, acquired at each time point, into a division line distance, a division line angle, and a curvature of division line of current position basis on the basis of the current position of the own vehicle, based on the moving distances in the front direction and the lateral direction of the own vehicle and the change amount of yaw angle from the acquisition time point of the division line information to the current time point.

9. The traveling lane recognition apparatus according to claim 1,
wherein the division line information estimator calculates the one estimation division line information by performing an averaging processing of the division line information of current position basis at the plurality of time points, about each of the division line on the left side and the division line on the right side of the own lane.

10. The traveling lane recognition apparatus according to claim 1,
wherein the division line information estimator estimates, about the each division line, past estimation division line information which is one division line information, based on the division line information of current position basis at a plurality of time points older than this time;
determines whether or not a deviation between this time the division line information of current position basis and the past estimation division line information is less than or equal to a deviation threshold value;
calculates the one estimation division line information, based on the division line information of current position basis at a plurality of time points including this time, when determining that the deviation is less than or equal to the deviation threshold value; and
calculates the past estimation division line information as the estimation division line information, when determining that the deviation is not less than or equal to the deviation threshold value.

11. The traveling lane recognition apparatus according to claim 10,
wherein, when the correspondence relation between the own lane and the each division line which was determined by the own lane determination storager changed, the division line information estimator decreases the deviation threshold value than when the correspondence relation is not changing.

12. The traveling lane recognition apparatus according to claim 10,
wherein, when determining that the deviation is not less than or equal to the deviation threshold value, the division line information estimator deletes the division line information which corresponds to this time the division line information of current position basis and was stored by the own lane determination storager.

13. The traveling lane recognition apparatus according to claim 1,
wherein the division line information estimator calculates, about the each division line, a variation degree of the division line information of current position basis at a plurality of time points of this time and past;
determines whether or not the variation degree is less than or equal to a variation threshold value; and
deletes the stored division line information at the plurality of time points of this time and past, and does not estimate the estimation division line information, when determining that the variation degree is not less than or equal to the variation threshold value.

14. The traveling lane recognition apparatus according to claim 13,
wherein, when the correspondence relation between the own lane and the each division line which was determined by the own lane determination storager changed, the division line information estimator decreases the variation threshold value than when the correspondence relation is not changing.

15. The traveling lane recognition apparatus according to claim 1, further comprising
a steering controller that performs one or both of a steering control which controls a steering angle of wheels, and a lane deviation informing which inform deviation of the own vehicle from the own lane, to a driver, based on the positional relationship of the own lane with respect to the own vehicle which was recognized by the traveling lane recognizer.

16. A traveling lane recognition method comprising:
acquiring division line information regarding position and shape of each division line on a basis of a position of an own vehicle, about division lines of one or a plurality of lanes which are recognizable in front of the own vehicle and include an own lane which is a lane where the own vehicle is traveling, and a lane adjacent to the own lane;
acquiring vehicle movement information regarding movement of the own vehicle from an acquisition time point of the division line information to a current time point;
converting the division line information at a plurality of time points of the each division line, into division line information of current position basis on a basis of a current position of the own vehicle at the plurality of time points of the each division line, based on the vehicle movement information;
determining a correspondence relation between the own lane and the each division line, based on the division line information of the each division line, and storing one or both of the division line information and the division line information of current position basis, at the plurality of time points of the each division line, by correlating with the correspondence relation;
estimating estimation division line information which is one division line information, based on the division line information of current position basis at the plurality of time points, about each of a division line on a left side and a division line on a right side of the own lane; and
recognizing a positional relationship of the own lane with respect to the own vehicle, based on the estimation division line information of each of the division line on the left side and the division line on the right side of the own lane.
